(19) United States
(12) Patent Application Publication
(10) Pub. No.: US 2025/0173740 A1
(43) Pub. Date: May 29, 2025

(54) METHOD AND SYSTEM FOR FREIGHT BROKER TRUST AUTHORITY

(71) Applicant: Transfix, Inc., New York, NY (US)

(72) Inventors: Jonathan SALAMA, Hoboken, NJ (US); Leonard TANCUAN, San Francisco, CA (US); Colin GALLO, Powell, OH (US)

(73) Assignee: Transfix, Inc., New York, NY (US)

(21) Appl. No.: 18/958,410

(22) Filed: Nov. 25, 2024

Related U.S. Application Data
(60) Provisional application No. 63/602,828, filed on Nov. 27, 2023.

(51) Int. Cl. G06Q 30/018

(52) U.S. Cl. CPC G06Q 30/0185

(57) ABSTRACT

A method for providing a trusted rate confirmation performed by a verified broker entity is provided. The method includes determining shipment information for a proposed shipment. The shipment information includes a carrier assigned to transport the proposed shipment and an issuer of a rate confirmation for the proposed shipment. The method includes generating a digital code based on the shipment information. The digital code is associated to the verified broker entity. The method includes generating a rate confirmation based on the shipment information. The rate confirmation includes the digital code and a rate for the carrier to transport the proposed shipment.

### CROSS-REFERENCE TO RELATED APPLICATIONS

This application claims priority to U.S. Provisional Application No. 63/602,828, filed Nov. 27, 2023, the entire disclosure of which is incorporated herein by reference.

### TECHNICAL FIELD

Disclosed are embodiments related to methods and systems for a freight broker trust authority.

### BACKGROUND

The truckload freight industry is susceptible to fraud and theft through a variety of vectors, one being that a bad actor offers freight for transit to a carrier (such as a trucking company) posing as a legitimate broker and issuing contracts (referred to as “Rate Confirmations” or “Ratecons”) under a legitimate broker's name. After the carrier has hauled the freight, the carrier bills the legitimate broker, who was never involved in the transaction and will not pay for the services. The carrier who has moved the goods is left unpaid, and the bad actor never pays for any services.

There are approximately 17,000+ trucking brokerages in the United States, as of 2022. There are about 1.2 million trucking companies operating in the United States. Given this environment, it is common for trucking companies to work with many brokers with whom they have no prior relationship or name recognition. Also, Ratecons are frequently issued digitally by email and accepted by written response. Consequently, documents are easy to forge.

### SUMMARY

Accordingly, there is a need in the field for improved security. Embodiments disclosed herein help to mitigate fraud by acting as a trust authority for brokerage companies, and by providing a method for carriers to validate the authenticity of both a Rate Confirmation and the broker issuing it, prior to a carrier's signing the agreement and hauling the shipment for the broker. Embodiments may be referred to using the term “Ratecon Shield,” which, depending on context, may also refer to a particular embodiment or product.

In embodiments, a freight broker “onboards” to the Ratecon Shield service by providing documentation about their company entity, which may be reviewed by Ratecon Shield staff as part of a validation process. A freight broker using a transportation management system (TMS) assigns a particular carrier to a truckload shipment, and generates a rate confirmation. The freight broker may make an API call to Ratecon Shield in order to generate a signed quick-response (QR) Code that is associated with the relevant details about the rate confirmation, including the legitimate issuer (i.e., the freight broker), and the QR Code is then embedded into the rate confirmation. In embodiments, the signed QR Code may be unique.

In embodiments, a carrier dispatcher, on receiving a rate confirmation, may scan a QR Code embedded into the agreement, e.g., using a mobile phone camera (or other QR Code scanning device or application). Scanning the QR Code may trigger the loading of a “Load Details Verification” webpage in a mobile browser, allowing the carrier dispatcher to compare the rate confirmation they have been presented with verified details from a trust authority to provide confidence that the issuer is legitimate.

According to a first aspect, a method for providing a trusted rate confirmation performed by a verified broker entity is provided. The method includes determining shipment information for a proposed shipment. The shipment information includes a carrier assigned to transport the proposed shipment and an issuer of a rate confirmation for the proposed shipment. The method includes generating a digital code based on the shipment information. The digital code is associated to the verified broker entity. The method includes generating a rate confirmation based on the shipment information. The rate confirmation includes the digital code and a rate for the carrier to transport the proposed shipment.

According to a second aspect, a method for verifying a trusted rate confirmation is provided. The method includes providing a rate confirmation. The rate confirmation includes a digital code. The method includes scanning the digital code. The method includes verifying the rate confirmation based on the scanned digital code.

According to a third aspect, a broker entity node is provided. The broker entity node includes processing circuitry; and a memory. The memory contains instructions executable by the processing circuitry, whereby when executed the processing circuitry is configured to determine shipment information for a proposed shipment. The shipment information includes a carrier assigned to transport the proposed shipment and an issuer of a rate confirmation for the proposed shipment. The processing circuitry is configured to generate a digital code based on the shipment information. The digital code is associated to the verified broker entity. The processing circuitry is configured to generate a rate confirmation based on the shipment information. The rate confirmation includes the digital code and a rate for the carrier to transport the proposed shipment.

According to a fourth aspect, a carrier entity node is provided. The carrier entity node includes processing circuitry; and a memory. The memory contains instructions executable by the processing circuitry, whereby when executed the processing circuitry is configured to provide a rate confirmation. The rate confirmation includes a digital code. The processing circuitry is configured to scan the digital code. The processing circuitry is configured to verify the rate confirmation based on the scanned digital code.

### BRIEF DESCRIPTION OF THE DRAWINGS

The accompanying drawings, which are incorporated herein and form part of the specification, illustrate various embodiments.

FIG. 1 illustrates a sequence diagram according to some embodiments.

FIG. 2 illustrates a sequence diagram according to some embodiments.

FIG. 3 illustrates an exemplary shipping order according to some embodiments.

FIG. 4 illustrates an exemplary rate confirmation according to some embodiments.

FIG. 5 illustrates using a QR Code scanning software application to read the QR Code embedded in the rate confirmation according to some embodiments.

FIG. 6 illustrates an exemplary Load Details Verified webpage to some embodiments.

FIG. 7 illustrates a sequence diagram according to some embodiments.

FIG. 8 illustrates a sequence diagram according to some embodiments.

FIG. 9 illustrates a system according to some embodiments.

FIG. 10 illustrates a flowchart according to an embodiment.

FIG. 11 illustrates a flowchart according to an embodiment.

FIG. 12 is a block diagram of an apparatus according to an embodiment.

### DETAILED DESCRIPTION

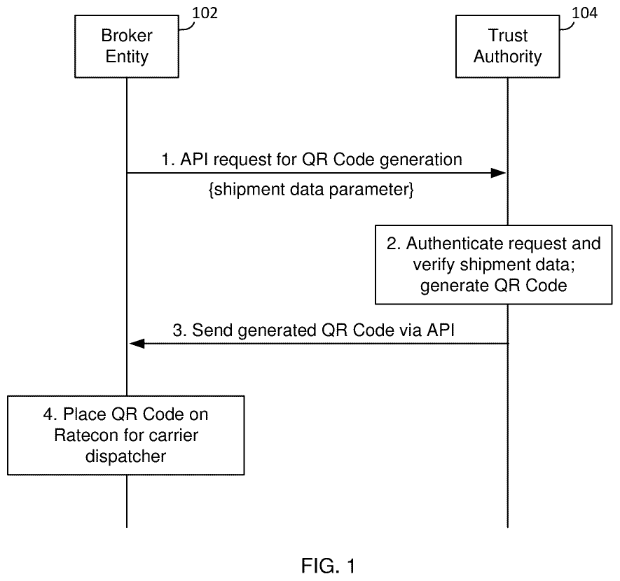

FIG. 1 illustrates a sequence diagram according to some embodiments. As shown, a broker entity 102 (e.g., a TMS user) is in communication with a trust authority 104 (e.g., a Ratecon Shield service provider). Broker entity 102 may communicate with trust authority 104 in order to create a rate confirmation having a signed QR code. For example, as part of creating the rate confirmation, broker entity 102 may initiate an API request to trust authority 104 for QR Code generation (step 1). The API request may include a shipment data parameter, which may include relevant information about the shipment and the broker entity 102. Trust authority 104 may then authenticate the request and verify the shipment data, and generate a QR Code based on the shipment data and an identity of the broker entity (step 2). The QR code may be signed, and may also be unique to the particular shipment data and broker entity information which may be provided in the shipment data parameter. Upon generating the QR Code, trust authority 104 may send the QR code toward the broker entity 102 (step 3). Upon receiving the QR code, broker entity 102 may place the QR code on the rate confirmation (step 4).

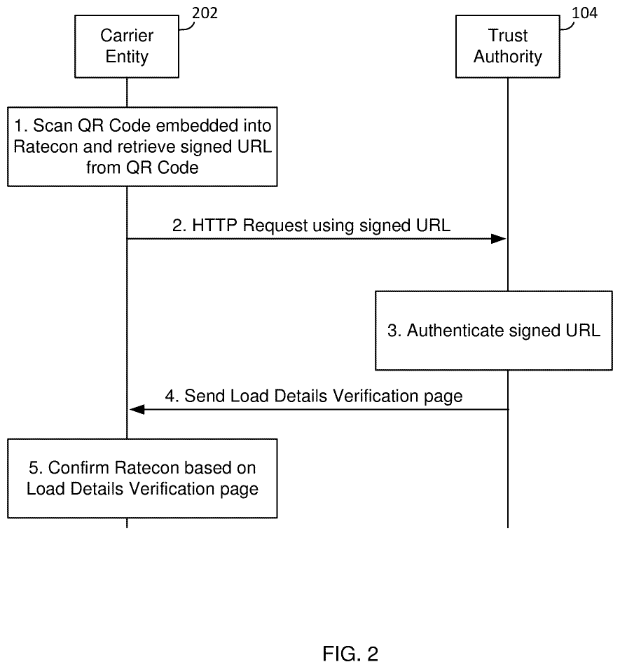

FIG. 2 illustrates a sequence diagram according to some embodiments. As shown, a carrier entity 202 (e.g., a carrier dispatcher) is in communication with a trust authority 104 (e.g., a Ratecon Shield service provider). Carrier entity 202 may communicate with trust authority 104 in order to verify a rate confirmation having a signed QR code. For example, as part of verifying the rate confirmation, carrier entity 202 may scan the QR Code embedded into the rate confirmation and retrieve a signed URL from the QR code (step 1). Carrier entity 202 may initiate an HTTP Request using the signed URL toward trust authority 104 (step 2). Trust authority 104 may authenticate the signed URL (step 3). Trust authority 104 may send a Load Details Verification webpage toward carrier entity 202 (step 4). For example, the Load Details Verification webpage may contain the shipment data and carrier information that the trust authority 104 was provided when trust authority 104 created the QR code for the rate confirmation that carrier entity 202 is attempting to verify. Carrier entity 202 may confirm the rate confirmation based on the Load Details Verification webpage (step 5). For example, carrier entity 202 may compare the information on the Load Details Verification webpage to the rate confirmation to ensure that they match. Carrier entity 202 may also confirm that the Load Details Verification webpage is associated with the trust authority 104, e.g., by checking that the appropriate URL is displayed.

Further details of the workflow are now described.

Registration with Ratecon Shield Web Service and Issuance of API Key: A broker entity 102 (e.g., a broker company) registers with a trust authority 104 (e.g., Ratecon Shield). As part of the registration, the broker entity 102 may provide documentation about their entity, such as a Certificate of Incorporation, a Tax Identification Number (TIN), and a Data Universal Numbering System (DUNS) number, some of which a trust entity 104 may require and some of which may be optional in order to register. The trust entity 104 may then review the documentation provided by the broker entity 102. For example, an account manager may review the validity of documents to confirm the validity of the broker entity 102, and may create a service account in a web service (e.g., a Ratecon Shield Web Service) for the broker entity 102. The web service may generate a (e.g., secret) API Key that is uniquely associated with the account for broker entity 102. Trust authority 104 (e.g., an account manager at trust authority 104) may share the API Key with broker entity 102 so that broker entity 102 may use the API Key in future API requests. Broker entity 102 stores the API key, e.g., in its TMS software, for use in issuing authenticated requests to the web service.

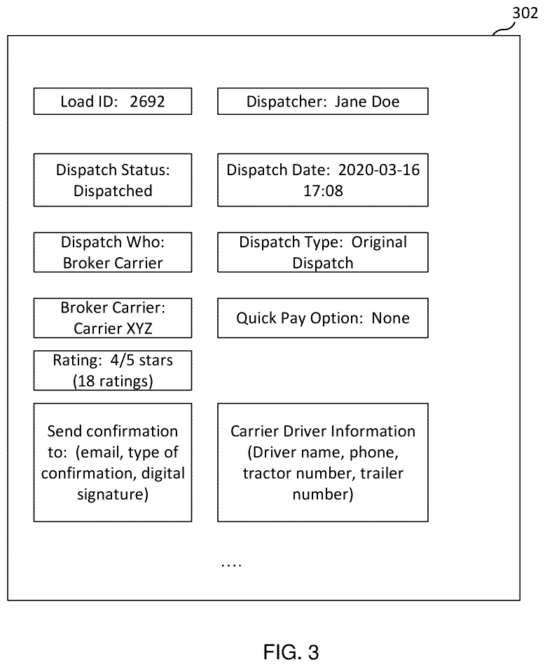

Creation of Rate Confirmation with QR Code: Broker entity 102 may create a new truckload shipment order in its TMS. FIG. 3 illustrates an exemplary shipment order 302. Among other information shown, a truckload shipment order may include data such as load number, pickup and drop-off locations and appointment times, purchase order (PO) identification (ID) Number, bill of lading (BOL) ID Number, required equipment type, and/or commodity type. Broker entity 102 may assign a shipment to a carrier company within broker entity's 102 TMS (shown as “Carrier XYZ” in FIG. 3). A carrier company record may include carrier company name, carrier dispatcher name, carrier driver name, and so on. An assignment of shipment may include a negotiated rate for the carrier company to haul the truckload shipment.

Broker entity 102 (e.g., via its TMS) may make an API request to a web service provided by trust authority 104 in order to retrieve a unique QR code representing the rate confirmation for the truckload shipment. The API request may include an API key assigned to the broker entity 102 by the trust authority 104, e.g., a unique, secret API key. The API request may include data describing the truckload shipment (e.g., load number, pickup and drop-off locations and appointment times, PO ID Number, BOL ID Number, required equipment type, commodity type). The API request may include data describing the assigned carrier company (e.g., carrier company name, carrier dispatcher name, carrier driver name). The API request may include the negotiated rate. The API request may be processed by the trust authority 104, which may then return (e.g., via a response to the request) a QR Code. The response may include, for example, a PNG image file representation of the QR Code that uniquely represents the data supplied about the rate confirmation, and includes a unique, encoded URL for a Load Details Verification webpage.

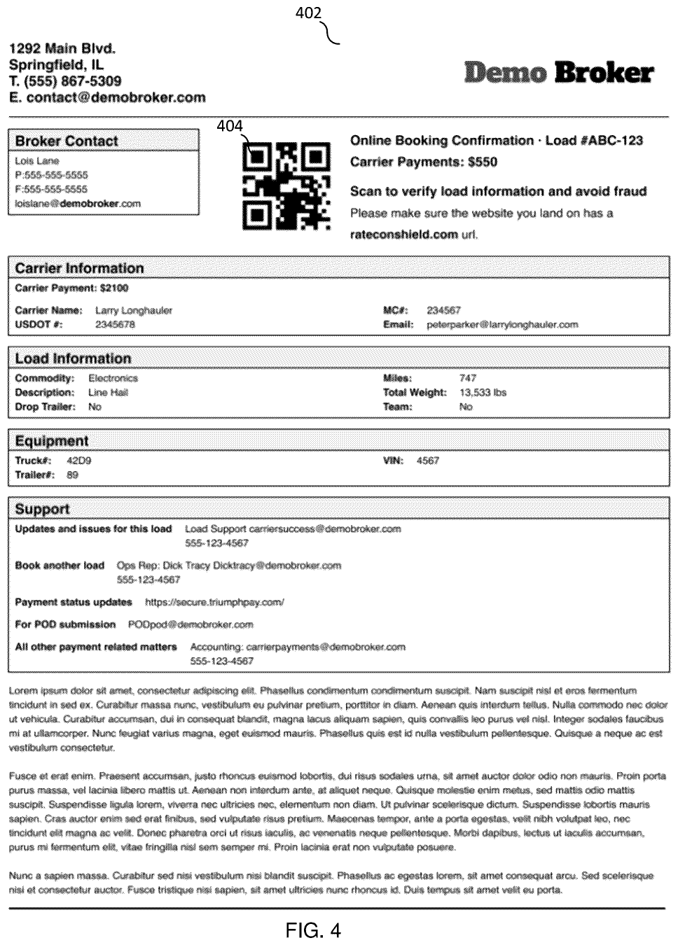

Upon receiving the QR Code, broker entity 102 (e.g., via its TMS) may embed the QR Code into the rate confirmation. For example, FIG. 4 illustrates an exemplary rate confirmation 402 according to an embodiment, having a QR Code 404 embedded into it. Broker entity 102 (e.g., via its TMS) may issue the rate confirmation (having the QR Code embedded into it) to a carrier entity 202. Upon receiving it, the carrier entity 202 may sign or otherwise indicate approval of the rate confirmation.

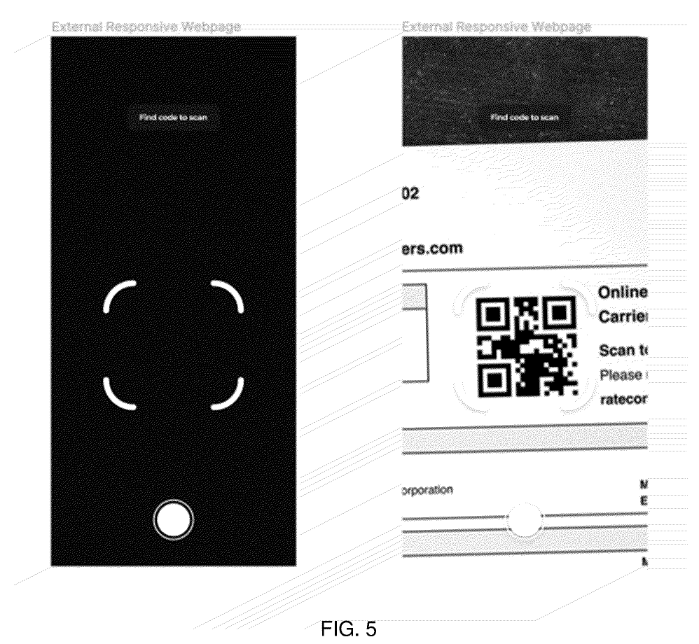

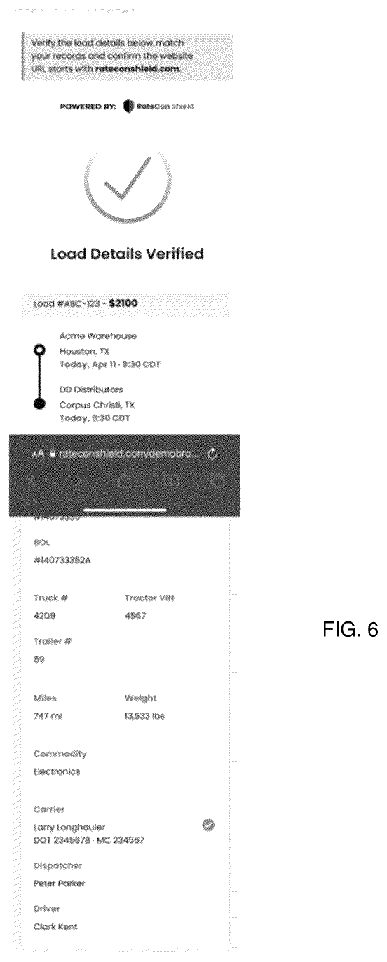

An example of a verification of a rate confirmation is provided, where the verification succeeds. A carrier entity 202 receives a rate confirmation from a broker entity 102. The carrier entity 202 may use a QR Code scanning software application (e.g., the camera application on iOS or Android smartphone) to read the QR Code embedded in the rate confirmation. FIG. 5 illustrates using a QR Code scanning software application to read the QR Code embedded in the rate confirmation according to an embodiment. The QR Code scanning software application may decode a unique URL from the QR code and cause the URL to open in a web browser. A web browser may request and display the unique Load Details Verification webpage represented by the URL. FIG. 6 illustrates a Load Details Verification webpage according to an embodiment. Carrier entity 202 may compare the details on the rate confirmation with the details displayed on the Load Details Verification webpage in the web browser to ensure they match, verifying authenticity of the rate confirmation and the authenticity of the broker entity 102 listed on the rate confirmation.

An example of a verification of a rate confirmation is provided, where the verification fails. A carrier entity 202 receives a fraudulent rate confirmation from a bad actor posing as a broker entity 102, where the rate confirmation includes a QR Code copied from a pre-existing rate confirmation from a different truckload shipment order. Carrier entity 202 uses a QR Code scanning software application (e.g., the camera application on iOS or Android smartphone), to read the QR Code embedded on the rate confirmation. The QR Code scanning software application decodes the unique URL from the QR code and opens the URL in a web browser. The Web browser requests and displays the unique Load Details Verification webpage represented by the URL. On seeing the webpage, the carrier entity 202 recognizes the details on the (fraudulent) rate confirmation do not match the details displayed on the Load Details Verification webpage in the web browser, thereby indicating that the rate confirmation has been falsified and was not issued by a legitimate broker entity 102.

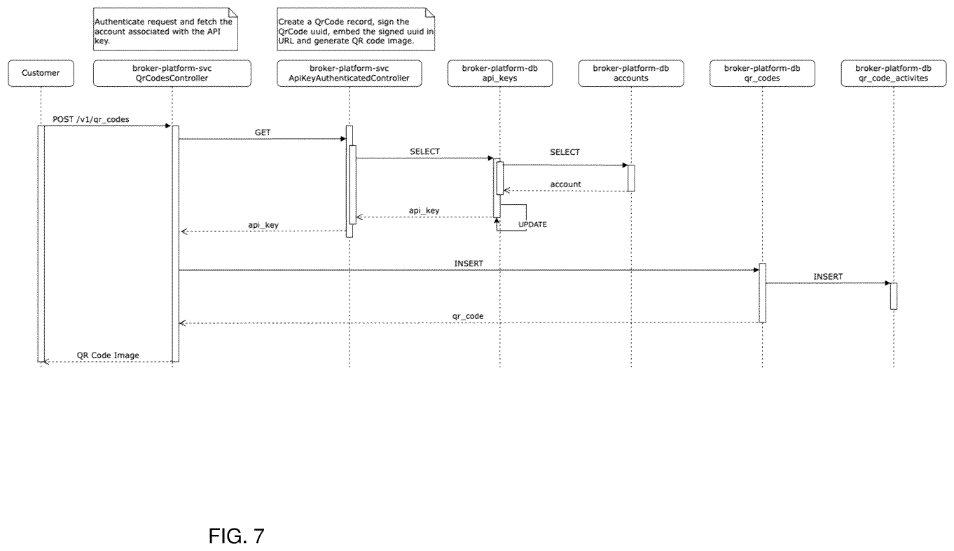

FIG. 7 illustrates a request to a trust authority's web service from a broker entity (e.g., via its TMS) for a QR Code according to an embodiment.

Broker entity's 102 TMS (shown as “Customer”) POSTs to API endpoint of Ratecon Shield Web Service (broker-platform-svc) to request a QR Code. The API request may include the broker entity's 102 unique API key. The API request may include data describing the truckload shipment (e.g., load number, pickup and drop-off locations and appointment times, PO ID number, BOL ID number, required equipment type, commodity type, and so on). The API request may include data describing the assigned carrier entity 202 (e.g., carrier company name, carrier dispatcher name, carrier driver name). The API request may include the negotiated rate.

Broker-platform-svc (operated by trust authority 104) authenticates the request by comparing the API key with a database of valid API keys, and associates the request with a database record associated with the broker entity 102.

Broker-platform-svc stores a database record (a Ratecon Verification Record) with data describing the truckload shipment, assigned carrier entity 104, and negotiated rate as provided in the API request.

Broker-platform-svc generates a (e.g., random, version 4) Universal Unique ID (UUID) and associates it to the Ratecon Verification Record, then signs the UUID, e.g., using a SHA-256 cryptographic hash with a secret token. This “signing” step is done to ensure that nobody has tampered with the UUID, or any other data that may be encoded within the QR Code.

Broker-platform-svc builds a unique URL for viewing the Load Data Verification webpage that is associated with the UUID.

Broker-platform-svc encodes the unique URL in a QR Code image.

Broker-platform-svc returns the QR Code image to the Broker Company's TMS in the body of the API response.

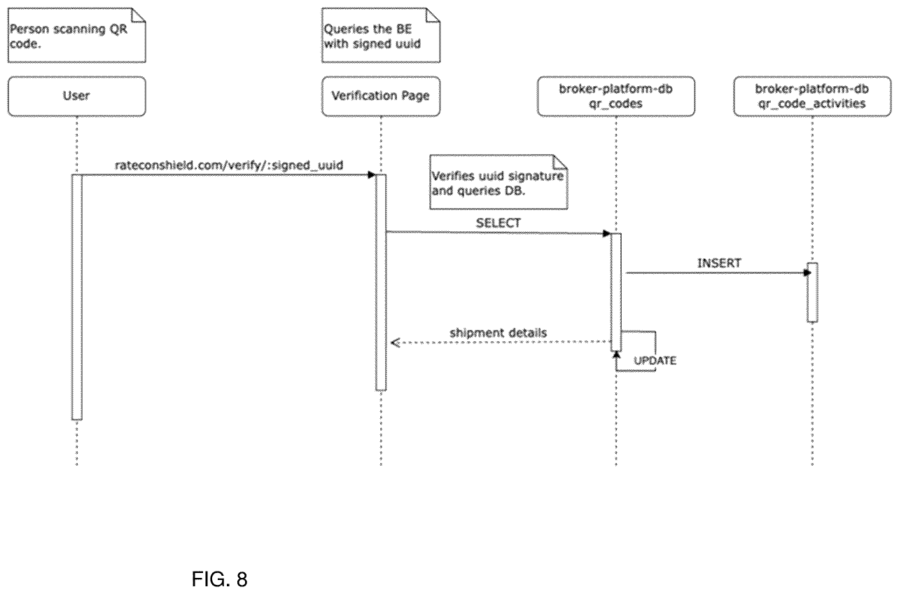

FIG. 8 illustrates a request to a trust authority's web service from a carrier entity for verifying a QR Code according to an embodiment.

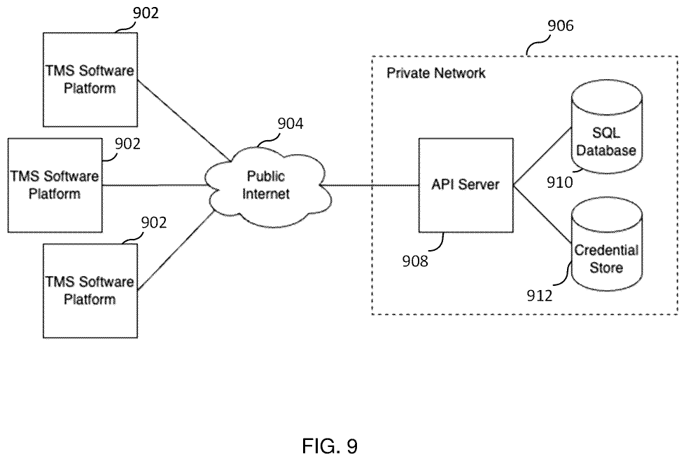

FIG. 9 illustrates a system according to an embodiment. As shown, one or more TMS software platforms 902 (e.g., operated by various broker entities 102) may be connected to the public Internet 904, and through the public Internet 904, to a private network 906 (e.g., operated by trust authority 104). Private network 906 may include an API server 908 (e.g., for handling the API requests described herein), and a SQL database 910 and a credential store 912.

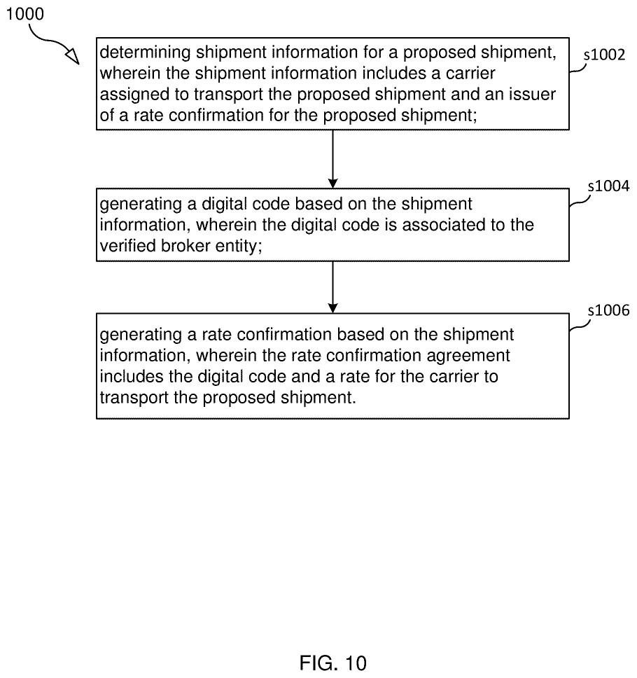

FIG. 10 is a flowchart illustrating a process 1000 for providing a trusted rate confirmation, according to an embodiment, performed by a verified broker entity 102. Process 1000 may begin in step s1002.

Step s1002 comprises determining shipment information for a proposed shipment. The shipment information includes a carrier assigned to transport the proposed shipment and an issuer of a rate confirmation for the proposed shipment.

Step s1004 comprises generating a digital code based on the shipment information, wherein the digital code is associated to the verified broker entity.

Step s1006 comprises generating a rate confirmation based on the shipment information, wherein the rate confirmation includes the digital code and a rate for the carrier to transport the proposed shipment.

In some embodiments, the digital code is a signed quick-response (QR) code and is embedded in the rate confirmation. In some embodiments, generating a digital code based on the shipment information comprises making an Application Programming Interface (API) call to a trusted authentication entity. In some embodiments, the API call to the trusted authentication entity includes a secret API key associated with the verified broker entity. In some embodiments, the secret API key is unique. In some embodiments, the shipment information further includes one or more of: a load number, pickup and/or drop-off locations, an appointment time, a Purchase Order (PO) Identifier (ID) Number, a Bill of Lading (BOL) Identifier (ID) Number, a required equipment type, and a commodity type.

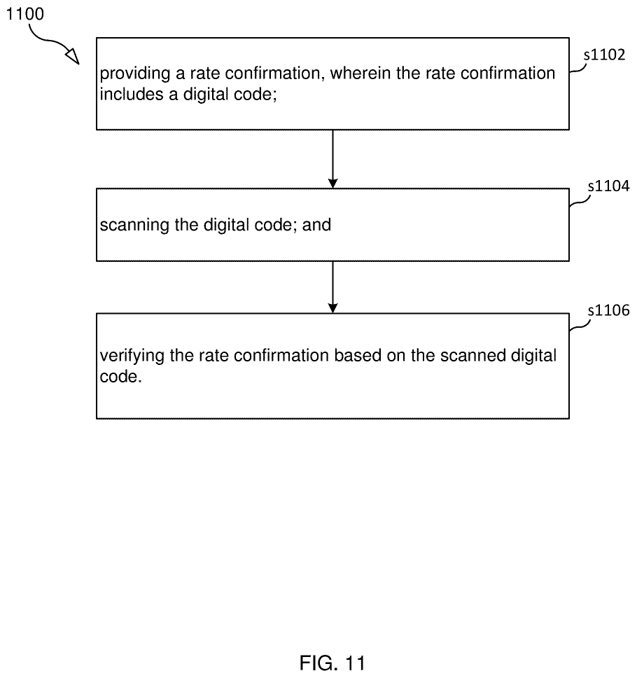

FIG. 11 is a flowchart illustrating a process 1000 for verifying a trusted rate confirmation, according to an embodiment, e.g., performed by a carrier entity 202. Process 1100 may begin in step s1102.

Step s1102 comprises providing a rate confirmation. The rate confirmation includes a digital code.

Step s1104 scanning the digital code.

Step s1106 comprises verifying the rate confirmation based on the scanned digital code.

In some embodiments, the digital code is a signed quick-response (QR) code and is embedded in the rate confirmation. In some embodiments, verifying the rate confirmation based on the scanned digital code comprises initiating a request to a trusted authentication entity including the scanned digital code and receiving authentication information from the trusted authentication entity.

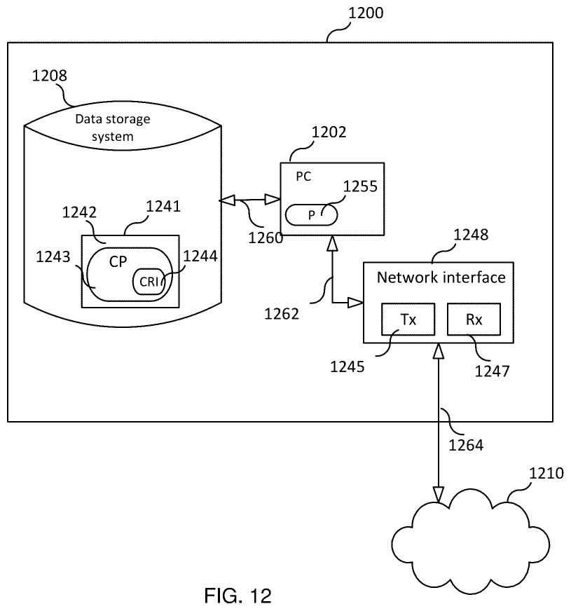

FIG. 12 is a block diagram of apparatus 1200 (e.g., a node operated by broker entity 102, trust authority 104, or carrier entity 202), according to some embodiments, for performing the methods disclosed herein. As shown in FIG. 12, apparatus 1200 may comprise: processing circuitry (PC) 1202, which may include one or more processors (P) 1255 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 1200 may be a distributed computing apparatus); at least one network interface 1248 comprising a transmitter (Tx) 1245 and a receiver (Rx) 1247 for enabling apparatus 1200 to transmit data to and receive data from other nodes connected to a network 1210 (e.g., an Internet Protocol (IP) network) to which network interface 1248 is connected (directly or indirectly) (e.g., network interface 1248 may be wirelessly connected to the network 1210, in which case network interface 1248 is connected to an antenna arrangement); and a storage unit (a.k.a., “data storage system”) 1208, which may include one or more non-volatile storage devices and/or one or more volatile storage devices. Interface 1260 may connect PC 1202 and storage unit 1208, interface 1262 may connect PC 1202 and network interface 1248, and interface 1264 may connect network interface 1248 and network 1210. In embodiments where PC 1202 includes a programmable processor, a computer program product (CPP) 1241 may be provided. CPP 1241 includes a computer readable medium (CRM) 1242 storing a computer program (CP) 1243 comprising computer readable instructions (CRI) 1244. CRM 1242 may be a non-transitory computer readable medium, such as, magnetic media (e.g., a hard disk), optical media, memory devices (e.g., random access memory, flash memory), and the like. In some embodiments, the CRI 1244 of computer program 1243 is configured such that when executed by PC 1202, the CRI causes apparatus 1200 to perform steps described herein (e.g., steps described herein with reference to the flow charts). In other embodiments, apparatus 1200 may be configured to perform steps described herein without the need for code. That is, for example, PC 1202 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described embodiments in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for providing a trusted rate confirmation performed by a verified broker entity, the method comprising:
determining shipment information for a proposed shipment, wherein the shipment information includes a carrier assigned to transport the proposed shipment and an issuer of a rate confirmation for the proposed shipment;
generating a digital code based on the shipment information, wherein the digital code is associated to the verified broker entity;
generating a rate confirmation based on the shipment information, wherein the rate confirmation includes the digital code and a rate for the carrier to transport the proposed shipment.

2. The method of claim 1, wherein the digital code is a signed quick-response (QR) code and is embedded in the rate confirmation.

3. The method of claim 1, wherein generating a digital code based on the shipment information comprises making an Application Programming Interface (API) call to a trusted authentication entity.

4. The method of claim 3, wherein the API call to the trusted authentication entity includes a secret API key associated with the verified broker entity.

5. The method of claim 4, wherein the secret API key is unique.

6. The method of claim 1, wherein the shipment information further includes one or more of: a load number, pickup and/or drop-off locations, an appointment time, a Purchase Order (PO) Identifier (ID) Number, a Bill of Lading (BOL) Identifier (ID) Number, a required equipment type, and a commodity type.

7. A method for verifying a trusted rate confirmation, the method comprising:
providing a rate confirmation, wherein the rate confirmation includes a digital code;
scanning the digital code; and
verifying the rate confirmation based on the scanned digital code.

8. The method of claim 7, wherein the digital code is a signed quick-response (QR) code and is embedded in the rate confirmation.

9. The method of claim 7, wherein verifying the rate confirmation based on the scanned digital code comprises initiating a request to a trusted authentication entity including the scanned digital code and receiving authentication information from the trusted authentication entity.

10. A broker entity node comprising:
processing circuitry; and
a memory, the memory containing instructions executable by the processing circuitry, whereby when executed the processing circuitry is configured to:
determine shipment information for a proposed shipment, wherein the shipment information includes a carrier assigned to transport the proposed shipment and an issuer of a rate confirmation for the proposed shipment;
generate a digital code based on the shipment information, wherein the digital code is associated to the verified broker entity;
generate a rate confirmation based on the shipment information, wherein the rate confirmation includes the digital code and a rate for the carrier to transport the proposed shipment.

11. A carrier entity node comprising:
processing circuitry; and
a memory, the memory containing instructions executable by the processing circuitry, whereby when executed the processing circuitry is configured to:
provide a rate confirmation, wherein the rate confirmation includes a digital code;
scan the digital code; and
verify the rate confirmation based on the scanned digital code.
